(19) United States
(12) Patent Application Publication
(10) Pub. No.: US 2008/0022918 A1
(43) Pub. Date: Jan. 31, 2008

(54) Dosage reminder. Plastic device that regulates prescription and non-prescription drug usage

(76) Inventor: John Gregory Fields, Athens, GA (US)

Correspondence Address: John G. Fields, 328 Harris Hill Drive, Athens, GA, 30607, US

(21) Appl. No.: 11/346,733

(22) Filed: Jul. 31, 2006

(51) Int. Cl. G01D 13/00

(52) U.S. Cl. 116/200

(57) ABSTRACT

This device is completely new to the field of prescription drug maintenance. Many have tried to answer the problem of when one has taken their medication, be it in the construction of plastic trays used in the separation of medications from day to day to the manufacture of mechanical and electronic devices to be installed into the cap of a prescription drug vial. Script Strip is a cheap and simple device that can be either affixed or manufactured into drug vials that immediately inform users of their last dose. It is mechanical not electrical in nature, flexible, cheap, and most importantly works perfectly to ensure on takes their drugs on time.

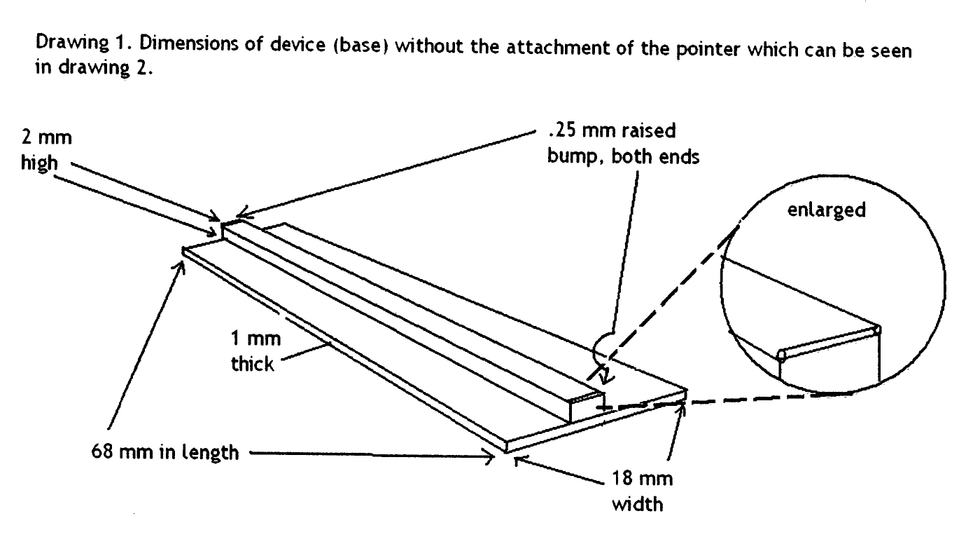

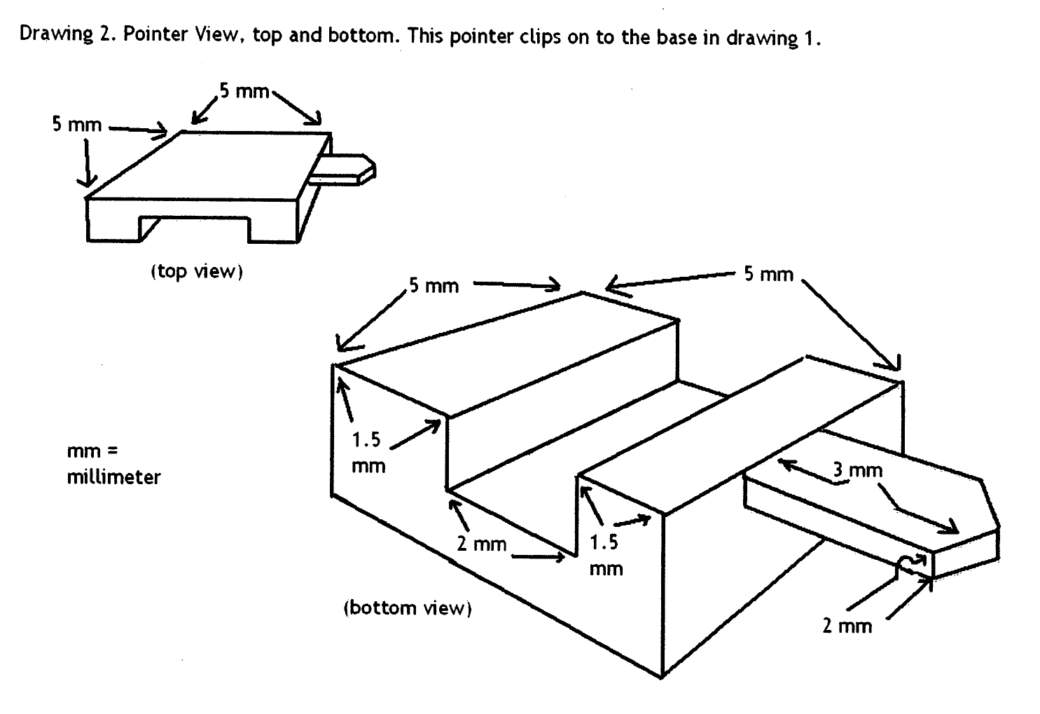

### CROSS REFERENCE TO RELATED APPLICATIONS

There are no other prior co-pending prior non-provisional applications of which to cross-reference.

### STATEMENT REGARDING FEDERALLY SPONSORED RESEARCH OR DEVELOPMENT

No federal funds were used in the creation of this invention. All funds were private.

### REFERENCE TO SEQUENCE LISTING, A TABLE, OR A COMPUTER PROGRAM LISTING COMPACT DISC APPENDIX

No compact disc or computer program is attached. All information necessary for the submission for patent is contained in the following pages.

### BACKGROUND OF THE INVESTIGATION

This device is a recorder of dosage for patients or users of prescription or non-prescription drugs, as specified in Class 346, paragraph 17, chapter 16. A problem exists today in that users of prescription and non-prescription drug users cannot remember if in fact a dose has been taken. This device attaches effortlessly or can in fact be manufactured into existing common prescription drug vials. Once attached, the users can then use the device to determine when their last dose was. The device does not use any electrical devices but rather is mechanical in nature and consists of basic plastics.

### BASIC SUMMARY OF THE INVENTION

The invention is a simple plastic strip with a moveable and attached red arrow that slides back and forth across the face of the device on a rail type configuration. The arrow points to numerous possible values on a decal of the device that represents a field or value that the user moves the arrow to that in turn represents when he or she last took their dose of medicine. The device is equipped with an adhesive backing that can allows it to be affixed to any existing medical vial (drug bottle). The arrow is then moved after the user takes their medicine and this then tells the user, by looking at one of the various values representing time of day or day of week, when their last dose has been taken. This device answers the ever-present riddle of when the last dose of medication was taken and does so by use of an inexpensive device that is described further below.

### BRIEF DESCRIPTION AND SEVERAL VIEWS OF THE DEVICE

The following is a detailed analysis along with specific instructions on how to construct and use the above-mentioned device.

This patent application is submitted with the full knowledge and understanding that all of the materials used in the construction of the aforementioned device have previously been granted numerous patents and have been used in countless other devices. What makes this device unique and separate from all previous devices is that this device incorporates the aforementioned technology and materials, combining the materials to create a new and different product that offers solutions to existing everyday problems. It is this unique product that has been submitted for patent, not the requisite materials are methodologies used in its construction.

The invention is a mechanical device that makes easier one's accounting and recording of their prescription and non-prescription drug use. It is a powerfully effective way to control and monitor drug management.

The device directly attaches to your prescription bottle in the free space either above or below the prescription label, to the side of the prescription bottle, or even part of the original prescription bottle plastic mold.

### DETAILED DESCRIPTION OF THE DEVICE

The physical device is constructed out of a flexible plastic and is a transparent off white color.

There are four unique designs that are submitted for patent. The size of the device submitted is 65 mm in length, 18 mm in width, and 1 to 1.5 mm thick and weighs 4 grams. The device is rectangular in design and comes in FOUR different models, Model A, B, C, and D. ALL models are of the same design, and the only difference between models is the printed labels. The mold does not change, only the labels.

The device can come in a multitude of colors, not only the off white transparent design that is submitted. This affords users the flexibility to label prescription vials certain colors that will assist in their recollection of what the contents of the bottle contain.

The device is constructed out of flexible plastic that is injected into a mold and later cooled. The finished form is then applied with an adhesive label that contains the information and literature needed to inform the user of how to operate the device.

The manner of operation of the device is quite simple. The device is shipped to the customer or pharmacy in bulk and in sheets containing 25 devices per side for a total of 50 devices per sheet. The devices can be sent with all the devices in a certain specific Model or with varying models in each sheet comprising different ratios of different models, dependent on the end users wishes. For example should the end user or customer desire only one model, such as cough suppressant bottles that only have the need to know when their last dose was taken and do not take doses as part of a daily regime, then that user would most probably only use Model A, which tells the end user the last day and time of dose. Other users or customers who take drugs on a daily or weekly basis would prefer Model B, C, or D to track their drug use. These Models would, theoretically, be used at pharmacies for example for those who take multiple doses each day or over period of several days or weeks.

Using the device is again quite simple, the user peels the device off of a sheet or also can just a simply peel the device off of a single unit if sold that way, and then applies the device to the side of a cough bottle, prescription vial, or any such suitable surface. The user then looks at the device and reads the accompanying literature, which instruct the user on its use. For example, let's say a user of “Viagra” has just bought the device or it has been placed there for him by a pharmacist. If he purchases the device, the first thing the user would do is remove the device from the plastic covering that protects the adhesive on the back of the device from accidental or “premature” exposure. This is especially relevant due to this type of drug. Secondly, the user then applies the device, sticky side to the vial or container of the drug that has been obtained/provided by the pharmacy and gentle applies the device so that is it securely affixed. The user then reads the device's literature that instructs him to “Take Rx, and then move arrow to today's date and time.” This tells the user to take his medicine or dose for that day/time and then position the moveable red arrow that is on the face of the device to the correct day and time. Once this has been done this tells the user a very important piece of information that ordinary bottle do not have, it tells him or her the last day and time of his last dose. Incredibly important, as with this drug it would have “lasting” repercussions that might injure or seriously hurt the drug user. Let's say for example that after a period of time the user of the drug becomes uncertain and somewhat less “confident” of their last dose and want to know when he last took the medicine. The user then simply looks to our device for help so that he can “inflate” his confidence as to when the last dose was taken. In this case, he simply ready the device where it is clearly marked “LAST DOSE” with an arrow, a phrase that is repeated several times, which instructs the ser when the last day and/or time of the dose was; and depending on the model it will tell the user if it was today (model A), yesterday in the AM or PM (Model B); either their first, second or third dose (Model C); or their first, second, third, or fourth dose (Model D).

These devices are perishable and can be thrown away with the prescription bottles.

The four models are:

Again, note the mold/device remains the same, the only thing that changes are the labels.

The device is limber, flexible, bendable, pliable, so that it can be bent in a concave shape and affixed to a cylindrical shape such as a pill bottle of at least 0.75 inches in diameter. The bend occurs along the “X” axis, not the “Y” axis.

For example:

The exterior of the device can be seen in above drawings.

The rear of the device contains an adhesive strip that covers the entire area of the device, and is protected by a plastic covering that can be removed when the users decides to place the device on a bottle face.

The adhesive is affixed to the rear of the device so that one must only remove the protective backing; place the device on a suitable prescription bottle, and the device “sticks” on by itself.

The devices come in standard sheets, 8″×11.5″ (standard paper size) where users remove the device from a sheet of many others and press it in on a surface, be it concave or flat. The user peels off the strips one at a time, like pulling address labels off a larger sheet.

The only moving or mechanical part on the device looks like is this railroad and plastic red marker which moves along the pathway with some resistance and can be moved REPEATEDLY from the left to right and right to left positions. The red indicator is able to move back and forth so that it does not move from an occasion bumping or impact with an object.

The words, phrases, and sentences used on the device are also unique to this device. The device reads,

### Model A:

### “TAKE Rx AND MOVE ARROW TO TODAY'S DAY”

### “MY LAST DOSE WAS”

### Model B:

### “TAKE Rx AND MOVE ARROW TO TODAY'S DAY AND TIME”

### “MY LAST DOSE WAS”

### Model C:

### “TAKE Rx AND MOVE ARROW TO TODAY'S DAY AND DOSE”

### “MY LAST DOSE WAS”

### Model D:

### “TAKE Rx AND MOVE ARROW TO TODAY'S DAY AND DOSE”

### “MY LAST DOSE WAS”

Obviously the different model literature is for users that take their dosages 1 time, 2 times, 3 times, and 4 times a day. They correspond to the Models like this:

### Model A: 1 dosage per day

### Model B: 2 doses per day, morning and night

### Model C: 3 doses per day

### Model D: 4 doses per day

It is also essential to note that these words and phrases that are written on the top of the device can be written in any language, English or other. This will be pertinent when applying for international patent.

The device models (A-D) can be applied one each per bottle by either the end user of a pharmacy. In the event of the device being part of a vial mold, a pharmacist makes the decision as to which bottle he uses (A-D) depending on the patient's dosage requirements. For example if the patient is suppose to take the medicine one a day, then the pharmacist would use “Model A,” and so forth. It is imperative that this device can be modified in such a way that the “rail” and “pointer” pieces of the device could be separated by cutting and placed, with the accompanying adhesive, directly on the vial of medicine or more easily the rail be manufactured with the vial as part of the initial vial manufacturing process. What is sought for patent is the device, be it the complete device or simply the rail and pointer being transferred, either as part of the initial mold or cut away from the device and used on the vial along with the accompanying decal that differentiates the various models.

### Variations in Size

It should be noted that all of the above devices are approximately 62 mm in length. This is a flexible number that can in fact change relative to the size of the vial. For example, if the plastic vial container from the pharmacy is smaller, the device can also be reduced to fir the size of the vial.

### Using the Device

The Script Strip is removed from a pre-packaged sheet by the user (pharmacy personnel or consumer), at which time the rear adhesive strip is exposed. The user then applies the flexible strip to the top or bottom of a prescription bottle and then physically moves the red cursor, takes their dosage for the day, and then physically moves the red indicator to the correct day of the week. Script Strip now serves as a constant reminder to the patient that their medicine has been taken for say, “Monday,” in easy and clear fashion. Once glance at Script Strip tells the users “Last Dose” (on device) was “Mon” (on device).

### Technical

The device submitted for patent is the culmination of numerous technical processes using a variety of chemicals and procedures.

The first such procedure necessary for the construction of this device is to manufacture a suitable mold measuring the exact dimensions submitted in the drawings below. The mold used to produce this device was constructed out of steel because it is resilient, hard, and lasting. To mold is constructed into parts, male and female, for the main body consisting of the top and bottom piece measuring the exact dimensions previously discussed, and a third and forth smaller mold is also constructed out of steel, again based on the dimensions set forth, for the Red Arrow that sits atop the device, the third and forth molds of course being for the manufacture of the red arrow. The material used in the construction of device is Ethylene Vinyl Acetate (EVA) will be described below.

The steel mold was cut using a three-dimensional pantograph that traced the hard copy that was hand made from wood. The device used to cut the mold was an Electronic Discharge Machining, or EDM. This machine works on the principle of “reverse welding” and uses an electrode to “burn” away the unwanted metal.

Once the molds have been completed or it is thoroughly cleaned and made ready for the next process, Thermoforming.

A plastic sheet of EVA some 5 millimeters (mm) in height and at least 10 centimeters (cm) in length and 5 cm in width is heated just below its softening temperature and then pressure is placed on it with the aforementioned male and female molds to produce the shape of the device. The two pieces of the mold are then pressed together by standard press. This includes the same process for molds three and four, the arrow pieces. Pressure and vacuum are used to achieve maximum wall thickness, uniformity, and strength. The resulting shape that exits this process forms the basis of the device submitted for patent.

Type of material used to construct this device is Sanren brand ethylene vinyl acetate copolymer (EVA 12/05). This substance provides excellent flexibility and when added to 6% standard white paint provides the necessary coloring for the device. A 6% red pain is used to color the red arrow that is to be applied to the device's railway pointer. The device as stated can also come in a variety of colors so that the user can pick and choose the right color for his or her own preference.

Once the actual mold has cured it is then inspected for any defects and if any found all are repaired. The next step in the process requires the printing of labels and fixing those labels to the front of the device. Labels are first created by drawing the initial rendering using a Windows software program called “Paint.” The rendering is then printed using a standard printer with special adhesive paper by 3m corporation using 3m adhesive stripping, which provides a sticky backing. Once the label is printed it is trimmed and the protective backing on the paper is peeled off and the exposed adhesive is applied to the front of the device with the writings and other markings seen in Models A, B, C, and D as show above.

The next step after the labels have been printed is to apply the label to the cooled mold that was earlier created. The next step is to attach the red arrow that was created in the above steps, which simply affixes on the device with a little hand manipulation.

The last step is to apply additional 3m Corporation Scotch Grip Plastic Adhesive on the back of the device leaving a protective covering with a 1 mm laminated white colored covering sheet made by the USI Lamination Company in Madison, Conn. The sheet is sheet to the dimensions of the device.

This is the manner in which the device is created and the method of which it is used.

The following are claimed for patent on this device:

1. All lettering, wording, expressions, and language as contained in the above drawings for each of the various models of Script Strip, to include but not be limited to the term “Last Dose was . . . ”

2. The idea of attaching an adhesive device to an existing prescription vial with requisite nomenclature that informs a user when their last dose of medication was taken.

3. The idea of incorporating the named device that is “script strip,” into the existing mold of a prescription vial, regardless of its size or shape. Several devices have been produced into the cap of a device; Script Strip is the only device that is attached to the vial that assists in prescription and non-prescription dose administration.

4. All designs, drawings, manufactured devices, and completed devices of Script Strip.

5. The idea of manufacturing a device, in sheet form, and peeled off much like address labels from a label sheet to be attached to prescription vials for the purpose of drug maintenance.

6. All colors and schemes present in the named device, Script Strip.
